(19) United States
(12) Patent Application Publication
(10) Pub. No.: US 2026/0338927 A1
(43) Pub. Date: Oct. 29, 2026

(54) LIDAR

(71) Applicant: AUTOX TECH PTE. LTD., SINGAPORE (SG)

(72) Inventors: Xi Zou, Shenzhen (CN); Yanan Zhi, Shenzhen (CN); Yizhou Shan, Shenzhen (CN); Jianxiong Xiao, Shenzhen (CN); Xuhui Tao, Shenzhen (CN); Zhenkun Wang, Shenzhen (CN)

(73) Assignee: AUTOX TECH PTE. LTD., SINGAPORE (SG)

(21) Appl. No.: 19/191,198

(22) Filed: Apr. 28, 2025

(51) Int. Cl. G01S 7/4914; G01S 7/481; G01S 7/4911

(52) U.S. Cl. CPC G01S 7/4914; G01S 7/4811; G01S 7/4818; G01S 7/4911

(57) ABSTRACT

The disclosure provides a LiDAR, including a laser transmitter, a pre-biased circulator, and a scanner. The laser transmitter is configured to emit a frequency-modulated continuous wave. The pre-biased circulator is configured to transmit the frequency-modulated continuous wave emitted by the laser transmitter to hit a plurality of targets, and receives a plurality of first echo signals reflected back by the plurality of targets. The pre-biased circulator comprises a predetermined optical fiber array, a plurality of optical fibers in the predetermined optical fiber array being arranged in sequence at different positions and at different angles to receive the plurality of first echo signals, the different positions and different angles are determined according to a predetermined algorithm. The scanner is configured to scan the frequency-modulated continuous wave transmitted by the pre-biased circulator, and receive the plurality of first echo signals, at a predetermined scanning rate.

### TECHNICAL FIELD

The disclosure relates to the field of imaging technology, and in particular to a LiDAR.

### BACKGROUND

The main role of a LiDAR is to perform three-dimensional imaging of the real world by emitting laser light and then measuring echo signals to obtain position information of a target. A coherent LiDAR has the advantages of strong anti-interference ability and high measurement accuracy in acquiring echo signals. However, the light source emitted by coherent LiDAR needs to be transmitted in an optical fiber, and a coaxial transceiver optical system must be used, and it is necessary to perform high-speed scanning in the X and Y directions respectively to obtain three-dimensional spatial imaging.

However, during the high-speed scanning process, due to the rapid rotation of the scanner, the laser signal incident on the target returns and is received after a period of time. When the echo signals re-enters the scanner, the scanner has already changed by an angle, and then it is received by the receiving lens, which will deviate from the 0-degree field of view of the receiving lens, resulting in a decrease in the optical fiber coupling efficiency.

The disclosure provides a LiDAR. The LiDAR includes a laser transmitter, a pre-biased circulator, and a scanner. The laser transmitter is used to emit a frequency-modulated continuous wave. The pre-biased circulator is used to receive and emit the frequency-modulated continuous wave, and to receive a plurality of first echo signals reflected back by the frequency-modulated continuous wave from a plurality of targets. The pre-biased circulator includes a predetermined optical fiber array, and a plurality of optical fibers in the predetermined optical fiber array are arranged in sequence at different positions and at different angles to receive the plurality of first echo signals. The scanner is used to scan the frequency-modulated continuous wave emitted by the pre-biased circulator and the plurality of first echo signals. The disclosure effectively solves the problem that the optical fiber cannot receive the echo signal due to the rotation of the scanner, and improves the working efficiency.

### SUMMARY

The disclosure provides a LiDAR capable of solving the problem that the optical fiber cannot receive the echo signal due to the rotation of the scanner, and improves the working efficiency.

The disclosure provides a LiDAR, including a laser transmitter, a pre-biased circulator, and a scanner. The laser transmitter is configured to emit a frequency-modulated continuous wave. The pre-biased circulator is configured to transmit the frequency-modulated continuous wave emitted by the laser transmitter to hit a plurality of targets, and receives a plurality of first echo signals reflected back by the plurality of targets. The pre-biased circulator comprises a predetermined optical fiber array, a plurality of optical fibers in the predetermined optical fiber array being arranged in sequence at different positions and at different angles to receive the plurality of first echo signals, the different positions and different angles are determined according to a predetermined algorithm. The scanner is configured to scan the frequency-modulated continuous wave transmitted by the pre-biased circulator, and receive the plurality of first echo signals, at a predetermined scanning rate.

In the disclosure, the optical fiber array is arranged in a coherent frequency-modulated continuous wave LiDAR. The optical fiber array has a plurality of polarization-maintaining optical fibers with different deflection angles. The different deflection angles are calculated based on the scanning rate of the scanner in the LiDAR and the position of the object, so that the echo signals reflected by the objects at different distances are received by corresponding optical fibers. This effectively solves the problem that the optical fiber cannot receive the echo signal due to the rotation of the scanner, and improves the working efficiency.

### BRIEF DESCRIPTION OF THE DRAWINGS

To more clearly illustrate the technical solutions in the embodiments of the disclosure or in the prior art, the following provides a brief introduction to the drawings required for describing the embodiments or the prior art. It is apparent that the drawings described below are merely some embodiments of the disclosure. For those skilled in the art, other drawings can be obtained based on the structures shown in these drawings without exercising inventive effort.

FIG. 1 is a structural diagram of a LiDAR in accordance with an embodiment.

FIG. 2 is a structural diagram of a pre-biased circulator in accordance with an embodiment.

FIG. 3 is an internal structural diagram of the LiDAR in accordance with an embodiment.

The realization of the objectives, functional features, and advantages of the disclosure will be further described in combination with the embodiments with reference to the drawings.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the disclosure and are not intended to limit the disclosure. Based on the embodiments in this application, all other embodiments obtained by ordinary technical personnel in this field without creative labor fall within the scope of protection of this application.

The terms “first,” “second,” “third,” “fourth,” etc. (if present) in the specification, claims, and accompanying drawings of the disclosure are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is important to note that the descriptions involving “first,” “second,” etc., in the disclosure are solely for descriptive purposes and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the disclosure.

The disclosure provides a LiDAR. The LiDAR is a frequency-modulated continuous wave LiDAR (FMCW LiDAR). The FMCW LiDAR can only receive the light emitted by itself and will not be affected by the light of other LiDARs. The frequency-modulated continuous wave LiDAR mainly sends and receives continuous laser beams reflected by a target, so that the echo signal and the local oscillator signal are coherently mixed to obtain a frequency difference between the transmitted signal and the received signal, and then the distance and velocity information of the target object is calculated based on the frequency difference.

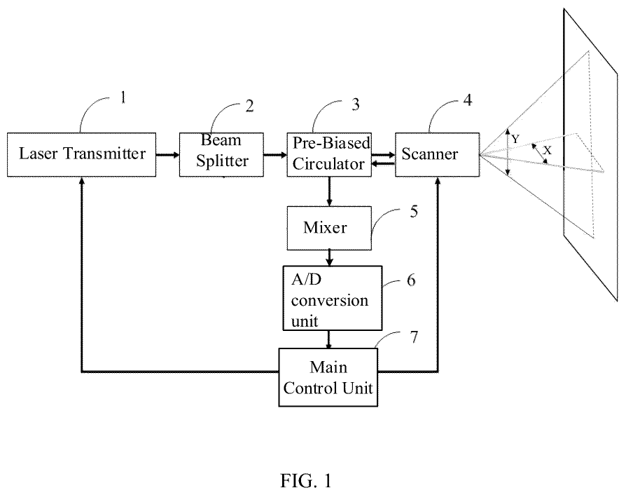

As shown in FIG. 1, it is a structural diagram of a LiDAR provided by a first embodiment of the disclosure. The LiDAR includes an FMCW laser transmitter 1, a beam splitter 2, a circulator 3, scanners 4 (X and Y), a mixer 5, an analog-to-digital conversion unit 6, and a main control unit 7. The FMCW laser transmitter 1 is connected to the beam splitter 2; the beam splitter 2 is connected to the pre-biased circulator 3; the pre-biased circulator 3 is connected to the scanners X and Y; the mixer 5 is respectively connected to the pre-biased circulator 3 and the beam splitter; the analog-to-digital converter 6 is communicatively connected to the mixer 5; and the main control unit 7 is communicatively connected to the analog-to-digital conversion unit 6. When the laser transmitter 1 emits a laser beam, it sequentially transmits through the beam splitter 2, the pre-biased circulator 3, and then is scanned by the scanner 4, and hits a target object and reflects a first echo signal; the first echo signal is scanned by the scanner 4 again, transmits through the pre-biased circulator 3 to become a second echo signal, is incident to the mixer 5, and is coherently mixed with a local oscillator signal emitted from the beam splitter 2 to the mixer 5 to obtain an intermediate frequency signal; the mixer 5 sends the intermediate frequency signal to the analog-to-digital conversion unit 6 to convert the intermediate frequency signal from an analog signal to a digital signal; the analog-to-digital conversion unit 6 sends the digital signal to the main control unit 7, and the main control unit 7 obtains information of the target object based on the digital signal, and generates a three-dimensional point cloud image based on the information.

The laser transmitter 1 is a continuous wave laser (CW laser), used to emit a frequency-modulated continuous wave laser, and the CW laser is applied in the frequency-modulated continuous wave LiDAR (FMCW LiDAR).

The beam splitter 2 is used to split the frequency-modulated continuous wave into two light signals, one light signal as outgoing light and one light as local oscillator light. There is a semi-reflective and semi-transmissive medium in the beam splitter, and the transmittance and reflectance ratio of the semi-reflective and semi-transmissive medium can be customized. The transmitted beam is used as outgoing light, and the reflected beam is used as local oscillator light. The local oscillator light and the outgoing light have different powers but the same frequency. When the outgoing light hits an object and is reflected, the frequency of the echo signal changes. For example, if the target object hit by the outgoing light is a moving vehicle, if the outgoing light meets the moving vehicle head-on, the frequency of the echo signal increases; if the outgoing light moves in the same direction as the moving vehicle, the frequency of the echo signal decreases.

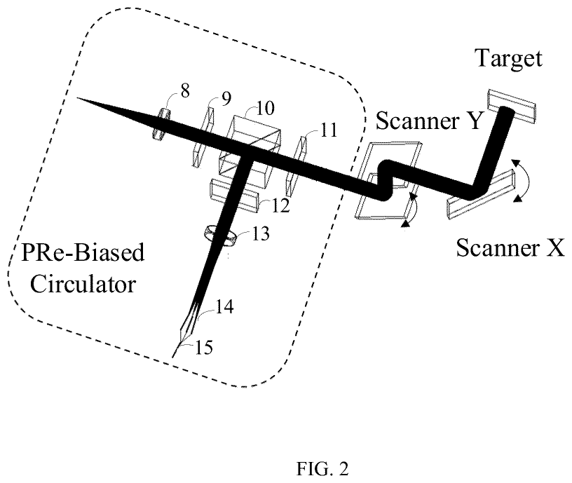

Referring to FIG. 2, a structural diagram of the pre-biased circulator 3 is illustrated. The pre-biased circulator includes: a transmitting collimator 8, a first half-wave plate 9, a polarization beam splitter prism 10, a Faraday rotator mirror 11, a second half-wave plate 12, a receiving collimator 13, a predetermined optical fiber array 14, and an optical fiber combiner 15. When a light beam is incident to the pre-biased circulator, it sequentially passes through the transmitting collimator 8, the first half-wave plate 9, the polarization beam splitter prism 10, and the Faraday rotator mirror 11. When the light beam hits the object and is reflected back to the pre-biased circulator, it sequentially passes through the Faraday rotator mirror 11, the polarization beam splitter prism 10, the second half-wave plate 12, the receiving collimator 13, the predetermined optical fiber array 14, and the optical fiber combiner 15.

The transmitting collimator 8 is used to converge the outgoing light. The outgoing light emitted from the beam splitter is divergent light, and the transmitting collimator converges the outgoing light so that the outgoing light has the same direction.

The first half-wave plate 9 is used to adjust the polarization state of the outgoing light by rotating around the optical axis of the wave plate, so that most of the outgoing light passes through the polarization beam splitter prism. The polarization beam splitter prism can split incident non-polarized light into two perpendicular linearly polarized lights, which are P-polarized light and S-polarized light respectively. The P-polarized light is light whose polarization direction is in a plane formed by incident light, reflected light, refracted light, and a normal line. The S-polarized light is light whose polarization direction is perpendicular to the plane formed by the incident light, the reflected light, and the normal line. The P-polarized light completely passes through, the S-polarized light is reflected at 45 degrees, and the outgoing direction is at a 45-degree angle to the P-polarized light. The first half-wave plate adjusts the polarization state of most of the outgoing light to the P polarization state so that most of the outgoing light passes through the polarization beam splitter prism.

The Faraday rotator mirror 11 is used to rotate the polarization state of the incident P-polarized light by a quarter of a circle. When the first echo signal, which hits the target object and is reflected, passes through the Faraday rotator mirror again, the polarization state of the first echo signal is rotated by a quarter of a circle again. At this time, it becomes a second echo signal. The polarization state of the second echo signal is rotated by two quarters of a circle in the P polarization state and becomes an S polarization state. When the S-polarized second echo signal is incident on the polarization beam splitter prism, because the polarization beam splitter prism reflects the S-polarized light, the second echo signal is reflected by the polarization beam splitter prism, and the reflection direction is at a right angle to the direction of the outgoing light.

The second half-wave plate 12 is used to adjust the polarization state of the second echo signal to meet the requirements of the polarization state of the transmission signal of the polarization-maintaining optical fiber in the predetermined optical fiber array 14. The polarization-maintaining optical fiber protects the polarization state of the echo signal, which can improve the accuracy of the obtained information of the target object. The polarization-maintaining optical fiber's ability to maintain the polarization state depends on the incident state of the polarized light, and it is required that the polarization state of the polarized light is coupled and aligned with the direction of the slow axis or the fast axis of the polarization-maintaining optical fiber.

The receiving collimator 13 is used to change the second echo signal emitted from the second half-wave plate from astigmatic light to light with the same direction. The receiving collimator has a convex lens that can focus incident light.

The optical fiber combiner 15 is used to combine light beams in the plurality of optical fibers into one beam of light.

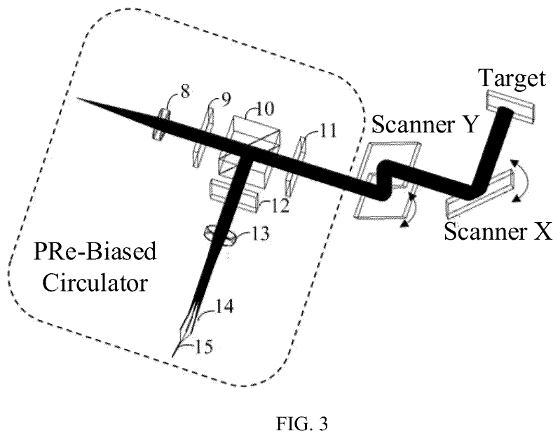

Referring to FIG. 3, the scanners 4 includes scanner X and scanner Y. Each of the X and the scanner Y is composed of a scanning motor and a reflecting mirror. The scanning motor and the reflecting mirror are connected through a scanning motor shaft, and the scanning motor shaft keeps rotating during the scanning process. The outgoing light emitted from the pre-biased circulator is sequentially reflected on the reflecting mirrors of the scanner Y and the scanner X, hits the target, is reflected back, is sequentially reflected on the reflecting mirrors of the scanner X and the scanner Y again, and enters the pre-biased circulator, and then is reflected by the polarization beam splitter prism to the predetermined optical fiber array.

However, during the process from reflection by the reflecting mirror of the scanner to reception, the scanning motor shaft rotates, that is, the reflection position of the outgoing light on the scanner and the reflection position of the echo signal on the scanner are different, and the echo signal cannot be received by the predetermined polarization-maintaining optical fiber; and the distance and speed of the object are different, and the reflection position of the echo signal on the scanner is also different.

Assuming that the scanner X scans at a frequency f1, the scanner Y scans at a frequency f2, the focal length of the receiving lens is F, and the speed of light is c; then the time taken for the light beam to be incident on the target at a distance L and for the echo signal to be reflected to the scanner is 2L/c. During this time, the scanner X rotates by an angle of 2Lf1360°/c, and the scanner Y rotates by an angle of 2Lf2360°/c; then, when the echo signal enters the receiving collimator, the incident angle deviates from the 0-degree field of view in the X direction by an angle of 2Lf 1360°/c, and deviates from the 0-degree field of view in the Y direction by an angle of 2Lf2360°/c; then, on the focal plane, the deflection angles of the optical fiber ends in the X and Y directions are set to ±2Lf1360°/c and ±2Lf2360°/c respectively, and the positions of the optical fiber ends are [±Ftan(2Lf2360°/c), ±Ftan(2Lf 1360°/c)], distributed in four corner directions of the 0-degree field of view.

In the case of different scanning frequencies of the scanner, different distances of the object, the calculated deflection angles of the optical fiber ends in the X and Y directions will also be different. And different optical fibers are arranged in the predetermined optical fiber array according to different deflection angles to receive the echo signals that deviate under the conditions of different scanning frequencies of the scanner and different distances of the object.

The mixer 5 is used to receive the light emitted from the optical fiber combiner, and to interfere with the local oscillator light emitted from the beam splitter to obtain an interference beat signal. The emitted laser beam hits the target object and is reflected. However, the movement speed of the object affects the frequency of the light. For example, if the target object moves towards the vehicle, the frequency increases; if the target object moves in the same direction as the vehicle, the frequency decreases. By interfering with the beat frequency, the frequency difference between the local oscillator light and the echo signal can be obtained, thereby calculating the distance information of the object.

The analog-to-digital conversion unit 6 is used to convert the interference beat signal in the mixer from an analog signal to a digital signal for analysis and processing by the main control unit.

The main control unit 7 is used to obtain the velocity and position information of the target object based on the digital signal, and to generate a three-dimensional point cloud image of the target object based on the velocity and position information.

It is apparent to those skilled in the art that various modifications and variations can be made to the disclosure without departing from the spirit and scope of the disclosure. In this way, and these modifications and variations of the disclosure are within the scope of the claims of the disclosure and their equivalent technologies, the disclosure also intends to include these modifications and variations.

The above-listed are only preferred embodiments of the disclosure, and of course cannot be used to limit the scope of the claims of the disclosure. Therefore, equivalent changes made according to the claims of the disclosure still fall within the scope covered by the disclosure.

1. A LiDAR, comprising:
a laser transmitter, configured to emit a frequency-modulated continuous wave;
a pre-biased circulator, configured to transmit the frequency-modulated continuous wave emitted by the laser transmitter to hit a plurality of targets, and receiving a plurality of first echo signals reflected back by the plurality of targets, the pre-biased circulator comprising a predetermined optical fiber array, a plurality of optical fibers in the predetermined optical fiber array being arranged in sequence at different positions and at different angles to receive the plurality of first echo signals, the different positions and different angles being determined according to a predetermined algorithm; and
a scanner, configured to scan the frequency-modulated continuous wave transmitted by the pre-biased circulator, and receive the plurality of first echo signals, at a predetermined scanning rate.

2. The LiDAR according to claim 1, further comprising a beam splitter, the beam splitter being configured to split the frequency-modulated continuous wave into a local oscillator light and an outgoing light, so that the outgoing light is incident to the pre-biased circulator.

3. The LiDAR according to claim 2, further comprising a mixer, the mixer being configured to receive the first echo signal and the local oscillator light, and to superimpose the first echo signal and the local oscillator light to generate a mixed signal.

4. The LiDAR according to claim 3, further comprising an analog-to-digital conversion unit, the analog-to-digital conversion unit being configuerd to receive the mixed signal, and to convert the mixed signal from an analog signal to a digital signal.

5. The LiDAR according to claim 4, wherein the LiDAR further comprising a main control unit, the main control unit being configured to obtain information of the plurality of targets based on the digital signal, and to generate a point cloud image based on the information, the information comprising distance information and velocity information.

6. The LiDAR according to claim 4, wherein the pre-biased circulator further comprises: a half-wave plate having a first half-wave plate and a second half-wave plate, the first half-wave plate being configured to adjust a polarization state of the frequency-modulated continuous wave to be a P polarization state.

7. The LiDAR according to claim 6, wherein the pre-biased circulator further comprises: a polarization beam splitter prism, configured to split the frequency-modulated continuous wave with the polarization state adjusted to the P polarization state into P-polarized light and S-polarized light, and to transmit the P-polarized light and reflect the S-polarized light.

8. The LiDAR according to claim 7, wherein the pre-biased circulator further comprises a Faraday rotator mirror configured to rotate the polarization state of the P-polarized light by a quarter of a circle, and to rotate the polarization state of the first echo signal by a quarter of a circle to obtain a second echo signal, and to be reflected by the polarization beam splitter prism.

9. The LiDAR according to claim 7, wherein the second half-wave plate is configured to adjust the polarization state of the second echo signal so that the adjusted polarization state is coupled and aligned with a fast axis or a slow axis direction of the plurality of optical fibers.

10. The LiDAR according to claim 7, wherein the pre-biased circulator further comprises an optical fiber combiner configured to combine a plurality of beams of light waves in the plurality of optical fibers into one beam of light wave.

11. A LiDAR, comprising:
a laser transmitter, configured to emit a frequency-modulated continuous wave;
a pre-biased circulator, configured to transmit the frequency-modulated continuous wave emitted by the laser transmitter to hit a plurality of targets, and receiving a plurality of first echo signals reflected back by the plurality of targets, the pre-biased circulator comprising a plurality of optical fibers arranged in sequence at different positions and at different angles to receive the plurality of first echo signals; and
a scanner, configured to radiate the frequency-modulated continuous wave transmitted by the pre-biased circulator, and receive the plurality of first echo signals, at a predetermined scanning rate.

12. The LiDAR according to claim 11, further comprising a beam splitter, the beam splitter being configured to split the frequency-modulated continuous wave into a local oscillator light and an outgoing light, so that the outgoing light is incident to the pre-biased circulator.

13. The LiDAR according to claim 12, further comprising a mixer, the mixer being configured to receive the first echo signal and the local oscillator light, and to superimpose the first echo signal and the local oscillator light to generate a mixed signal.

14. The LiDAR according to claim 13, further comprising an analog-to-digital conversion unit, the analog-to-digital conversion unit being configured to receive the mixed signal, and to convert the mixed signal from an analog signal to a digital signal.

15. The LiDAR according to claim 14, wherein the LiDAR further comprising a main control unit, the main control unit being configured to obtain information of the plurality of targets based on the digital signal, and to generate a point cloud image based on the information, the information comprising distance information and velocity information.

16. The LiDAR according to claim 14, wherein the pre-biased circulator further comprises: a half-wave plate having a first half-wave plate and a second half-wave plate, the first half-wave plate being configured to adjust a polarization state of the frequency-modulated continuous wave to be a P polarization state.

17. The LiDAR according to claim 16, wherein the pre-biased circulator further comprises: a polarization beam splitter prism, configured to split the frequency-modulated continuous wave with the polarization state adjusted to the P polarization state into P-polarized light and S-polarized light, and to transmit the P-polarized light and reflect the S-polarized light.

18. The LiDAR according to claim 17, wherein the pre-biased circulator further comprises a Faraday rotator mirror configured to rotate the polarization state of the P-polarized light by a quarter of a circle, and to rotate the polarization state of the first echo signal by a quarter of a circle to obtain a second echo signal, and to be reflected by the polarization beam splitter prism.

19. The LiDAR according to claim 17, wherein the second half-wave plate is configured to adjust the polarization state of the second echo signal so that the adjusted polarization state is coupled and aligned with a fast axis or a slow axis direction of the plurality of optical fibers.

20. The LiDAR according to claim 17, wherein the pre-biased circulator further comprises an optical fiber combiner configured to combine a plurality of beams of light waves in the plurality of optical fibers into one beam of light wave.
